(19) United States
(12) Patent Application Publication
(10) Pub. No.: US 2003/0029814 A1
(43) Pub. Date: Feb. 13, 2003

(54) Efficient disposal of fluid waste

(76) Inventors: William Begell, New York, NY (US); Anatoliy Dolinsky, Kiev (UA); Vyacheslav Olegovich Kremnev, Kiev (UA); Yelena Shafeyeva, New York, NY (US)

Correspondence Address: KENYON & KENYON, 1500 K STREET, N.W., SUITE 700, WASHINGTON, DC, 20005, US

(21) Appl. No.: 10/173,710

(22) Filed: Jun. 19, 2002

Related U.S. Application Data
(60) Provisional application No. 60/298,875, filed on Jun. 19, 2001.

(51) Int. Cl. C02F 1/00

(52) U.S. Cl. 210/769

(57) ABSTRACT

The present invention relates to the disposal of fluid waste containing organic matter and water in a manner that utilizes the energy potential and the heat capacity of the contaminating matter in the waste. The energy potential and the heat-generating capacity of the organic matter is used to dispose thereof with minimal energy input from an outside source.

This application claims priority to, and incorporates in its entirety, the U.S. provisional application No. 60/298,875 filed Jun. 19, 2001. This application also incorporates herein by reference application No. 10/082,062 in its entirety.

### FIELD OF INVENTION

The present invention relates generally to production and disposal of a stable emulsion and/or new fuel from oil-contaminated water and other liquid industrial waste containing organic matter and water.

### BACKGROUND DISCUSSION

Conventionally, the fluid waste containing organic matter and water is subjected to various processes to lower the content of the contaminating matter to a level not exceeding the limiting allowable concentrations. The values of the limiting allowable concentrations are determined by various governmental agencies for each type of contaminants. The values of limiting allowable concentrations depend also on the intended application of the purified waste (e.g., technical reversal, return to natural water reservoir having fish breeding basins, etc.)

The contaminating matter of organic origin is usually classified into three groups. The first group includes organic matter suspended in water within limits of fine to large particles. The second group includes hydrophilic and hydrophobic colloidal systems of various types (e.g., substances of high-molecular weights and detergents capable of changing aggregation based on the environment's conditions.) The third group of contaminants includes molecular solutions. Molecular solution containing particles such as sugar refinery waste and other vegetation products.

Conventional technologies for purifying the first group include mechanical separation in separating vessels, filtration in slow filters, micro separation in micro-filters and separation through centrifuging. Other methods include adhering the contaminant with highly dispersed and granular matter. In this method, the contaminated solution is filtered through a fluid layer of a auxiliary matter in diatomic or other fluid filters to form a coagulated suspension. Thereafter, the coagulated suspension is filtered through double layer and course granular filters using granular layers along with flocculants for process augmentation. This method can also include contact coagulation-filtration where contaminant is contacted with aluminum bisulfate, FeCl, polyacrilomide and/or active silicon acid or other such ingredients designed to reduce the contaminant's level. In still another method for treating the first group of contaminants aluminum, iron hydroxides and/or clay mineral is used to adhere and separate the contaminants. This method includes treating the contaminants with aluminum and iron hydroxide and mineral clay to form coagulants and treating coagulants with sulfated clay-earth, FeCl or ferrous-sulfate. Yet a further conventional aggregation technique process the contaminants with coagulants and flocculants to form aggregates. The aggregates are thereafter processed through various separation and filtration steps to reduce the contaminant's level.

Conventional techniques for purifying contaminants of the second group includes oxidation whereby a contaminated matter is chlorinated or ozonated. Another conventional technique includes absorption using aluminum or iron hydroxide along with highly dispersed clay mineral. Still another method for purifying the second group of contaminants includes aggregation using cationic flocculants.

Finally, conventional techniques for purifying contaminants of the third group includes desorption aeration (including sprayers, aerators and degassing equipment), oxidation (including chlorinating, ozonating and treatment with potassium permanganate), electrolysis, adsorption through treatment with activated carbon, organic extraction and biochemical decomposition through treatment by aerobic microorganisms. Treatment with biochemical and biological microorganisms requires considerable energy expenditure in order to maintain an optimal temperature (approximately 36-39° C.) to sustain the vitality of the microorganisms and to provide aeration.

Because a typical fluid waste contains all three types of contaminants, purification plants include technological processes directed at implementing the various treatments discussed above.

While only a few of the above-identified techniques are capable of treating waste to the allowable level, other factors such as treatment time and the required capital investment render these processes more popular than the processes that readily meet the allowable contaminant level. Devising proper treatment plants that meet the maximum allowable contaminant level requires considerable technical complexity and high equipment cost. Further, the operation costs of such plants are also rather significant. These costs, for example, include operation costs relating to personnel, energy and treatment material (flocculants, coagulants, activated charcoal, reagents, etc.) Finally, the operation of the purification plants itself produces new waste in the form of flakes, coagulated precipitants, etc. which in turn can cause ecological problems, requiring additional treatment.

The efficiency of combustion of viscous fuels in the form of fine water emulsions has been discovered but has been impractical because of the absence of a reliable technology for the preparation of the required finely dispersed emulsions.

Also, the recent trends in oil refining have caused an increase in the heavy fraction in the fuel balance. The combustion of such highly viscous paraffin-containing complex substances, mineral admixtures, and frequently sulfur, brings about considerable difficulties. Moreover, the relatively high water content of such fractions cause additional problems during waste treatment process as the heavy oil may contain more than 20-50 wt. % water forming a rough and unstable emulsion. Combustion of such rough emulsions is unstable at best as it is often accompanied by a unstable flame and an increase in soot formation. Heavy fuel oil or heavy oil is considered to have differing viscosity. The viscosity of heavy fuel oil is considered to vary in range from 5 E at 40° C. to 16 E at 80° C.

In addition, drying and gasification processes are energy intensive and expensive. Technologies that include sludge handling and transfer that utilize drying and gasification involve relatively high energy consumption. Therefore, the drying is both economically and energetically inefficient.

### SUMMARY OF THE INVENTION

The claimed invention overcomes the above-enumerated disadvantages. Specifically, the technology operates without the need to introduce additional heat or energy resources. Further, the equipment cost can be minimal in that the existing production line can be used with little, if any, modification.

In one embodiment, the present invention relates to the disposal of fluid waste in a manner that utilizes the energy potential and the heat capacity of the contaminating matter in the waste. In another embodiment, the energy potential and the heat-generating capacity of the contaminated matter is used to dispose the contaminated matter with minimal energy input from an outside source.

### BRIEF DESCRIPTION OF THE DRAWINGS

The various features of the invention will best be appreciated by simultaneous reference to the description which follows and the accompanying drawings wherein like numerals indicate like elements, and in which:

FIG. 1 illustratively compares the emulsified composition of water in oil (a) prepared according to the PET principles with a conventionally emulsified composition of water in oil (b).

FIG. 2 schematically represent one embodiment of the invention.

FIG. 3 schematically represents another implementation of according to one embodiment of the invention.

FIG. 4 schematically represents one embodiment of the invention as applicable to a thermoelectric plant.

### DETAILED DESCRIPTION OF AN EMBODIMENT OF THE INVENTION

Preliminarily, it is noted that sources of organic waste can include compounds containing slurry and/or sludge, oil-polluted water and chemicals from oil tankers and other vessels as well as water contaminated by oil waste, water contaminated with organic waste, petroleum waste, and heavy-fraction with water residues. While this list is not exhaustive, it is noted that storage and treatment of such contaminants can be rather costly and energy intensive. The organic content of the water can typify petrochemical byproducts and can range from 1 wt. % to 99 wt. %.

Accordingly, the principles of the instant invention contemplate providing several advantages over the conventional methods, for example, the treatment with microorganisms which is rather costly and energy intensive. According to one embodiment of the invention, the energy potential and the heat capacity of the underlying organic waste is used to dispose thereof with minimal energy input from the outside.

In one embodiment, the present invention enables production of a fine, combustible stable emulsion, a new file, derived from the oil-contaminated water and various fluid industrial waste. The embodiments of the invention can bring about environmental and energy saving applications that are equally applicable for the disposal of fluid waste, including water and contaminating matter of organic origin. For example, the principles of the invention can be applied in ports, industrial plants and other locations where fluid waste contaminated by organic matter is found. Finally, in one embodiment, the present invention produces a combustible stable emulsion from the organic-contaminated matter and various industrial waste, providing the following exemplary advantages: decreasing stack gas pollutants such as CO by half, NOₓ by 20-30% and an overall reduction of ash content of the stack gas. Still another advantage of the principles of the invention includes utilizing the energy potential and heat-generating capacity of the contaminating matter contained in the waste as an energy source.

The fluid waste containing water and polluting substances of organic origin typically represent a dispersed system within a continuous liquid phase, containing individual particles in the dispersed phase. If the continuous phase is water or an aqueous solution and the dispersed phase consists of organic matter, then such emulsion can identified as a direct emulsion denoted by O/W (“Oil in Water”). On the other hand, if the continuous phase consists of a liquid organic and water (or aqueous solution) is dispersed therethrough, then such an emulsion can be identified as a lipophilic emulsion and can be denoted by W/O (“Water in Oil”).

Typically, liquid waste forms an unstable system having the tendency for separation within the volume of such waste. Moreover, many such systems separate into compositions having simultaneously both direct and lipophilic emulsions. The particles of the dispersed phase may be of different sizes and shapes and represent spheroids, lenses, layers, plugs, etc. Such a waste composition cannot be readily combusted because the composition cannot maintain the conditions necessary to sustain a stable combustion reaction. That is, the contaminated waste composition is not a readily combustible material, and if combusted, provides for incomplete combustion producing many undesirable by-products and consuming unnecessarily large amounts of combustion energy.

When the necessity arises to provide stable combustion of a liquid water-containing fuel, two additional conditions must be met in addition to the requirements for burning liquid fuel without water. First, the total amount of water in the fuel should not exceed the limiting value by 40-50 wt. %, preferably 12-20 wt. % for efficient utilization of generated heat and/or power, and 20-40 wt. % for total environmental waste disposal. The emulsion can be a lipophilic emulsion, noting that an O/W emulsion is difficult to bum because it can consume substantial amounts of energy for combustion. Water (or another aqueous solution) can be present in the form of a finely-dispersed phase within the bulk of the liquid fuel. This condition is readily apparent when considering water's heat absorption during vaporization and the resulting incomplete combustion should the content of water exceed the limiting value.

The second condition requires that, in a lipophilic emulsion, the water droplets be present as spheroids within the fuel droplets. In this regard, it should be noted that the combustion of a lipophilic emulsion takes place in the combustion chamber in a boundary layer of water and around the moving fuel droplets. When the fuel heats water will gradually evaporate. When the liquid waste contains water, the water droplets should be present as spheroids within the moving droplets of the fuel. That is, the liquid fuel containing water that enters the combustion chamber should represent a finely-dispersed emulsion of the lipophilic type prior to its atomization. When this condition is not met (such as cases where (1) the emulsion is direct O/W, where water spheroids exceed one micron or (2) where the water spheroids are not uniformly dispersed over the total volume of the mixture), the water-containing liquid fuel loses its ability for stable combustion. This occurs even when the content of water in the fuel is much smaller than the limiting value. One reason for this is the presence of a water film on the surface of the fuel drops disturb fuel vaporization.

According to an embodiment of the present invention, during the initial phase of combustion and upon reaching a predetermined temperature, water spheroids contained within the fuel drops begin to boil and produce steam. Initially, the steam causes expansion of the fuel drop and converts it to a thin membrane. Subsequently, the steam causes the collapse of the fuel drop into fine components, ultimately causing self-atomization of the emulsified fuel. At the same time the contact area between the fuel and the oxidizer (e.g., oxygen from the ambient air) increases considerably, intensifying combustion and improving the contents of combustion gases.

According to one embodiment of the invention, organic waste containing water is dispersed in the fuel prior to combustion. Since the compositions containing organic waste can differ from each other, various ratios of waste, water and fuel can be employed. In one embodiment of the invention, the introduction of organic waste containing water can be specifically calculated to obtain a lipophilic emulsion. In one embodiment, this can be attained by preliminarily dispersing water waste into a continuous phase. The continuous phase can be oil, waste or used oil, fuel, fuel by-product and/or used fuel and other compositions that are readily combustible. The continuous phase can contain as much as 20% water. If there is more than 20%, the composition have a tendency to become a O/W and not an W/O emulsion. As stated the addition of surfactant can assist emulsification. Dispersion can be noticeably intensified for fuels with a high viscosity and an inability for atomization. Thus, for example, in an embodiment where a conventional heavy oil product (such as Bunker Oil, Navy special fuel oil, acid sludge and pitch or No. 5 or No. 6 fuel oil) is emulsified with organic waste containing water, the fuel efficiency can be reached where the emulsion contains 10-20 wt. % water. It will be noted that other emulsions containing more than 20 wt. % are still well within the scope of the present invention. Applicants note however that in the range 10-20 wt. %, the fuel efficiency can be optimized since the increased intensification of combustion due to the presence of organic matter fully compensates the heat losses due to vaporization of the water.

Depending on the viscosity of the liquid fuel, one or more stabilizer can be added to the waste/fuel mixture. Such stabilizer, or combinations thereof, can be specifically selected to complement the underlying waste/fuel compositions. Moreover, the stabilizer, or combinations thereof, can be mixed with or added to the fuel prior to the introduction of the waste; can be combined with fuel and waste simultaneously; or can be introduced after the waste sludge has been introduced into the fuel. As stated the stabilizer or the surface active agent can include a combination of more than one agent so long as such combination can provide phase stability during storage and transportation. Moreover, in some cases heavy fuel chemical composition can act as stabilizer and thus circumvent the need to introduce additional stabilizer. For example, heavy oil contains tar-like or asphalt-type substances that can provide stability and shelf-life for the emulsion for up to several years. Thus, in embodiments of the invention which utilize fuels of high viscosity (e.g., heavy oil), addition of the surface active agent or stabilizer can be unnecessary. Non-exhaustive example of heavy oils includes No. 5 and No. 6 fuel oil, navy special fuel oil, bunker C oil and acid sludge and pitch.

In one embodiment of the invention, a surface active agent is added to the fuel prior to introduction of the water-containing waste at a ratio of less than 1 wt. %. The amount of surface active agent can be varied depending on the desired stability, shelf life of the final emulsion. For some compositions, the addition of 1 wt. % surfactant can provide up to two years of stability to the emulsion.

As stated, the embodiments of the present invention can also utilize the energy potential and/or heat-generating capacity of the contaminating matter contained in the waste. By way of example, during the measured introduction of liquid waste containing water and organic contaminants into a liquid fuel, approximately 10 wt. % of the organic matter in the waste can provide the additional energy needed to vaporize the water contained therein. The energy generated from combusting the balance of the organic contaminants can be used for the commercial production of heat energy. Finally, analysis of smoke stack samples from fuel containing organic waste and water, as compared to samples without water, reveal that the stack gasses are cleaner when water is included in the liquid fuel. It can be postulated that the presence of water assists in providing a more complete combustion.

In one embodiment of the invention, the processing of contaminated organic waste takes place in the following manner. In this embodiment, the liquid waste can represent an unstable and rough emulsion containing both direct and lipophilic emulsions which can readily separate into two phases and/or have combination of layers direct over lipophilic and vice versa. The composition of the liquid waste can contain any number of organic products. For example, the liquid waste can contain organic material produced as a result of petrochemical processing. In addition, the liquid waste can contain water up to a limiting amount. The limiting amount can vary depending on the viscosity of the fuel as will be discussed in greater detail herein below. In one embodiment of the invention, liquid waste containing water and polluting matter of organic origin can be delivered in a measured amount into a volume of a liquid fuel having a surface active agent and dispersed therein. It can be appreciated by one of ordinary skill in the art that the ratio of the liquid waste to fuel can be varied depending on the composition of the liquid waste, the amount of water and the type of fuels used. In an exemplary embodiment where the liquid waste contains approximately 70 wt. % water and 30 wt. % organic matter, and where the fuel is No. 6 residual fuel, an approximate ratio of 1:1 liquid waste to fuel can be used. Where one ton of waste to one ton of fuel is utilized, the final result can yield as much as 20% of additional energy in addition to elimination of the waste. While other processing steps can be interchangeably used, in one embodiment of the invention, a surface active agent can be added to fuel prior to introducing liquid waste. Thereafter, the liquid waste can be introduced into the fuel/emulsifier composition and dispersed according to the principles of this invention. While conventional mixing and emulsification can be implemented, inventors have discovered that nano-emulsification can be most effective since phase separation does not occur readily. In one embodiment of the invention, the resulting mixture can be a finely-dispersed emulsion which may be stored or burned in an incinerator. It is important to note that according to this embodiment of the invention, the ratio of water in the fuel should not exceed 50 wt. %.

The surface active agents (or surfactant) that can be used with the embodiments of the invention can include any of a number of surfactants that have albuminous and other organic origins. The amount of the surfactant and the surfactant's composition can be selected according to the composition of waste, economical and ecological factors. Moreover, a combination of two or more surfactants can be used to complement the particular waste emulsion being treated. Non-exhaustive examples of common surfactants include OP-10, sulfanol, refined sun flower, etc.

As stated, the inventors have found that a mixture of the liquid waste, fuel and stabilizer is most stable when nano-dispersed. In one embodiment, the finely-dispersed lipophilic emulsion can be implemented by using a nano-dispereser adapted to deliver a burst of energy in the form of a pulse lasting for one or more nano-seconds. That is, the nano-disperser can be adapted to provide bursts of energy lasting not more than one or more nano-seconds. The disperser head or the homogenizer can optimally have dimensions commensurate with the dimensions of individual molecules or molecule clusters at the boundary of the phase interface. Such bursts of pressure can be introduced as pulses in the pulsing apparatus, the nano-disperser, operating on the basis of the so-called PET-Principle. The pulses can cause perturbation of the boundary layer around particles with diameter of 1-2 microns thereby placing an unusually high amounts of pressure and relative velocity on the particles. Thus, the original large scale molecules and molecule clusters are transformed through the electromechanical processes and the static forces of both the dipole molecules and colloidal films with a thickness will transform into a stabilized dispersed system. The isolation of the surface of the micro-spheroids of water within the droplet of liquid fuel will cause cavitation within the droplets. The pulse will also destroy the paraffinic complexes in the heavy oil which is accompanied by the disruption of the intermolecular bonds and other molecular forces. The resulting homogeneous mixture can thus contain finely dispersed water within the fuel drops and contribute to the formation of a nano-scale homogeneous emulsion.

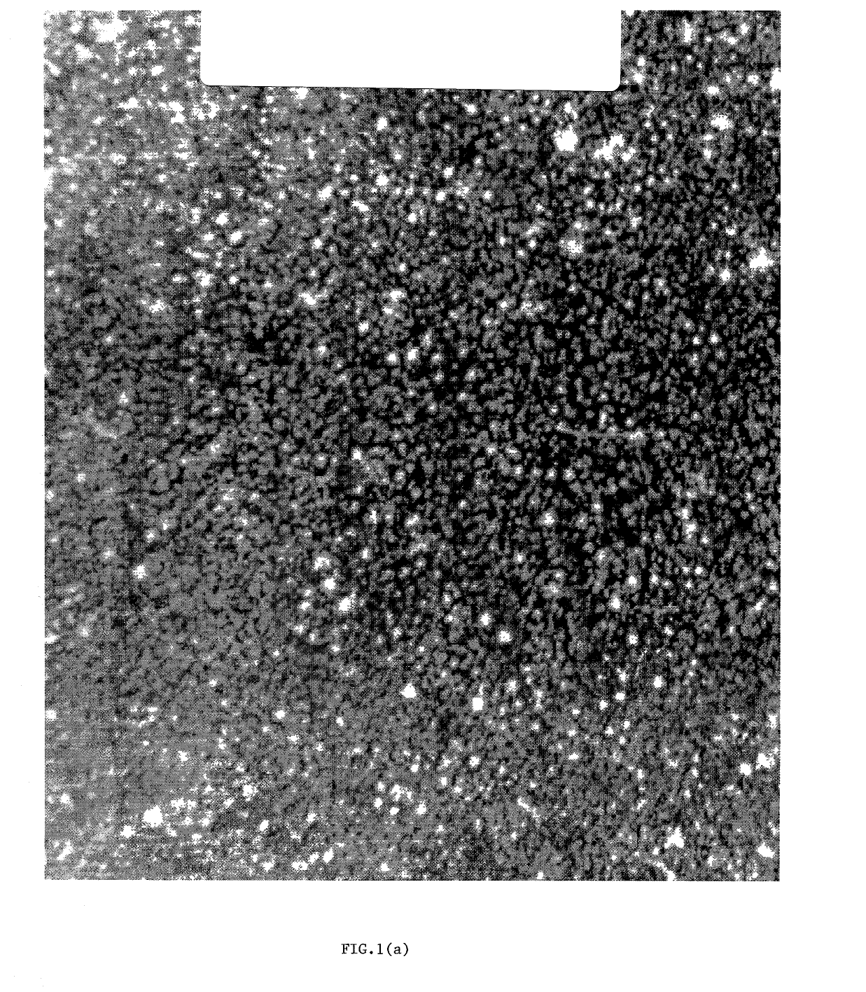

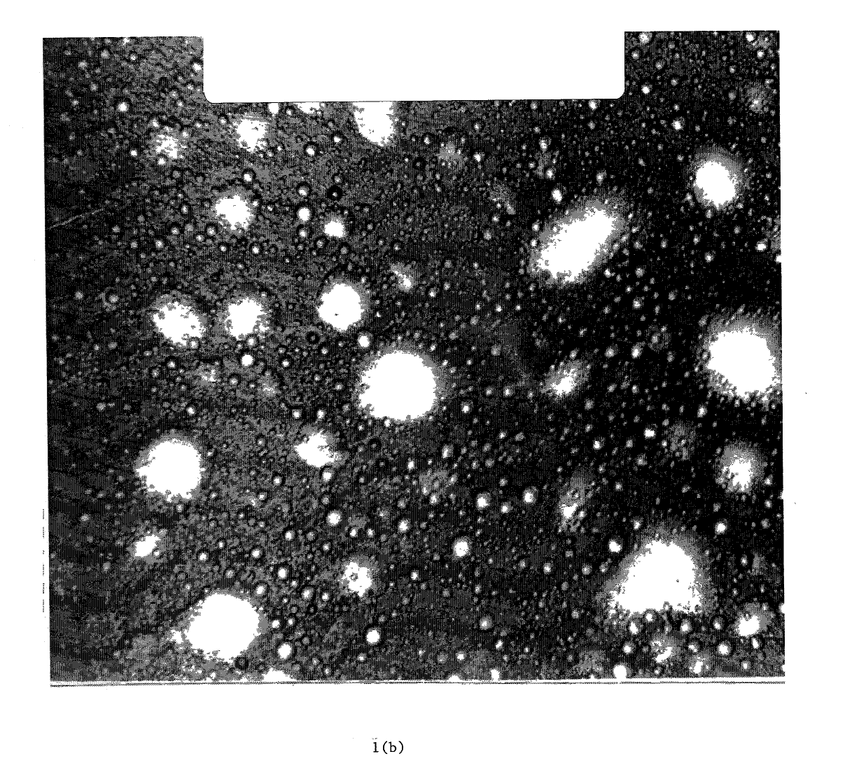

FIG. 1 illustratively compares the emulsified composition of water in oil (a) prepared according to the PET principles with a conventionally emulsified composition of water in oil (b). As illustrated in FIG. 1, an emulsified composition prepared according to the PET principles represents a fine emulsion as compared with the conventionally emulsified composition.

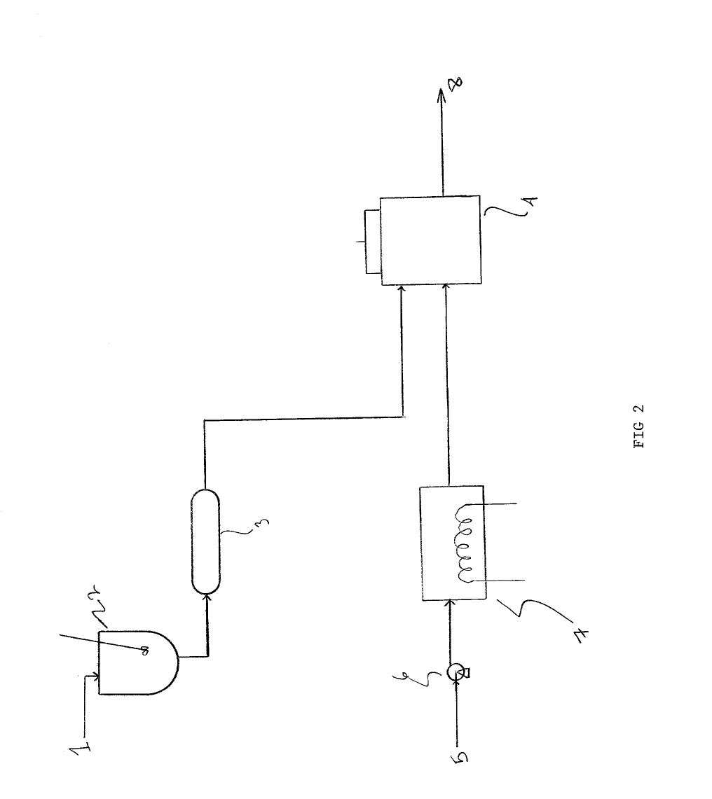

FIG. 2 schematically represents one embodiment of the invention. Referring to FIG. 2, liquid waste containing organic matter and water is first treated at mixer 2. While not shown in FIG. 2, it is within the scope of the invention to subject stream 1, containing water and organic matter, to a mechanical or chemical filtration process prior to the mixing step. Moreover, while the schematic representation of FIG. 2 depicts a rotary mixer, application of any other mixing device or homogenizer is well within the scope of the invention. Simultaneously, liquid fuel 5, is supplied through pump 6 to heater 7. It is noted that while a preheating step is demonstrated in FIG. 2, this step may be eliminated or postponed until later stages of the treatment. The liquid composition is then supplied through dosimeter 3 which will meter the waste composition in pre-determined amounts prior to admixing with the liquid fuel. The mixture of the liquid fuel and liquid waste is then processed to produce nano-emulsified composition 8, which can be supplied to a steam boiler for incineration.

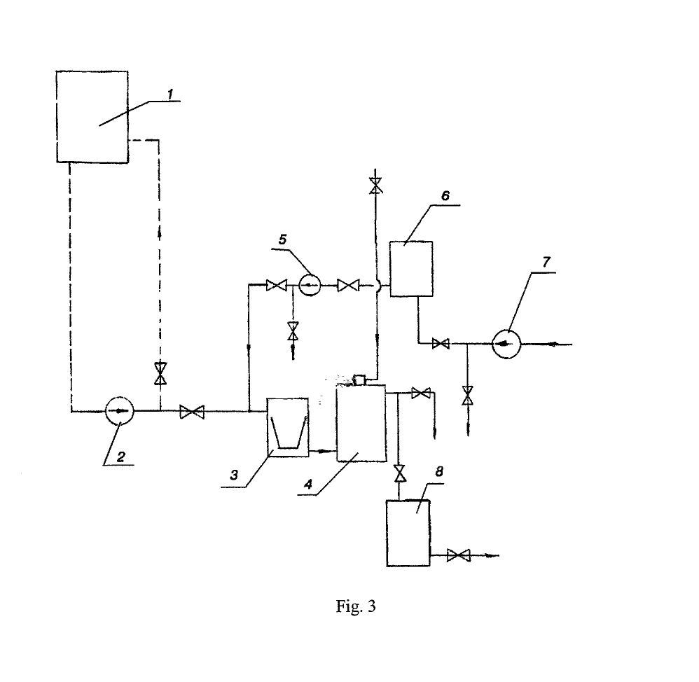

FIG. 3 schematically represents another implementation according to one embodiment of the invention. Referring to the embodiment of FIG. 3, sludge waste is introduced through pump 7 to the intermediate tank 6 where surfactant is metered through pump 5 and filter 3 to PET disperser 4. Surfactant can be introduced directly to PET disperser 4 through supply line 9. Heavy fuel oil, stored in tank 1, can also be supplied through pump 2, filtered through filter 3 and directed to PET disperser 4. It is noted that the process diagram of FIG. 3 enables each of surfactant, sludge waste and fuel oil to be supplied independently. That is, if the process requirements do not call for surfactant, its presence can be eliminated without affecting the sludge waste or the fuel oil. The emulsified composition is then supplied to storage tank 8 for storage prior to incineration. The embodiment of FIG. 3 is especially suited for applications where the water content of the sludge can demand more or less fuel. Under this circumstances, the fuel supply pump 2 can be controlled to increase or decrease the amount of heavy oil or fuel as needed.

In another embodiment of the invention, waste including water and organic pollutant can be introduced directly into a heavy oil liquid fuel without the addition of surfactants. Because heavy oil can contain large amounts of oxidants, the addition of surfactant may be unnecessary. According to this embodiment, the liquid waste is introduced, in measured amounts, with the heavy oil liquid fuel to form a finely-dispersed lipophilic emulsion. Thereafter, the emulsion can be burned at a steam boiler or stored for future applications. In one embodiment, the lipophilic emulsion can include micro-spheroids of water (and undesirable paraffinic or other petrochemical compounds) homogeneously dispersed within the droplets of liquid fuel (the liquid fuel can constitute the continuous phase).

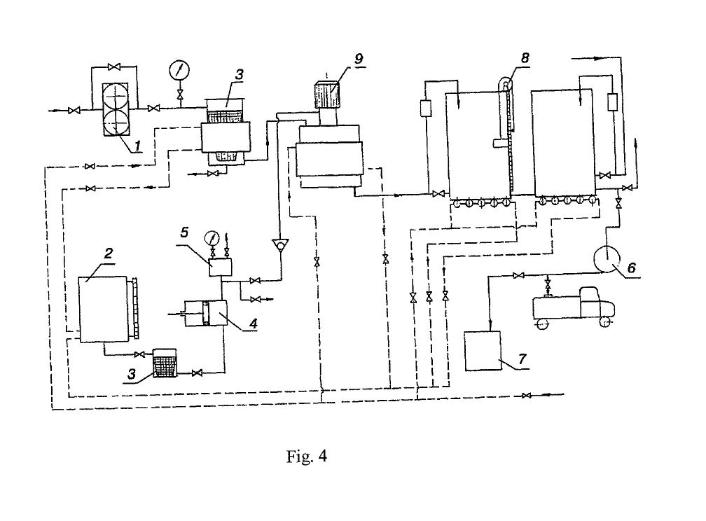

FIG. 4 schematically represent one embodiment of the invention as applicable to a thermoelectric plant. Referring to FIG. 4, sludge containing organic matter and water as produced in an exemplary thermoelectric plant is pumped into metering pump 1. A bypass valve is proved over the pump installation. Although FIG. 4 schematically illustrates a metering pump, it is understood that the invention is not limited thereto and other means for providing measured amounts of sludge can be utilized. The sludge is supplied to filter 3. In the embodiment of FIG. 4, filter 3 is jacketed for heating and cooling. Broken lines in FIG. 4 represent steam lines. Steam is supplied through steam generation plant 2 to serve various units in the plant. Nano-disperser 9, operating according to the PET principles, receives filtered sludge from filter 3 and produces an emulsion to be supplied to tanks 8. As can be noted, in the embodiment of FIG. 4, the sludge is readily combustible and therefor it is not added to fuel. This is because the sludge waste typical of a thermoelectric plant is heavy oil (up to 50% fuel oil or waste fuel oil) and can be combusted readily without additional fuel. In addition, because the sludge is heavy fuel, surfactants have not been added (though it may be added if the need arises). From tanks 8, emulsified sludge which can be used as combustible fuel can be shipped or stored at tank 7 for future consumption. The steam generation plant includes expansion tank 5, positive displacement pump 4 and filter 3. Because stem generating plant is an auxiliary plant, it will not be discussed in detail.

In yet another embodiment of the invention, contaminated liquid waste (containing, among others, water and polluting matter of organic origin) can be housed in a container allowing gravity separation of the heavier fluid. Other conventionally known methods can also be used to bring about the phase separation. While different compositions may have different results, in one embodiment, the upper layer can contain as much as 80 wt. % organic matter as compared with the weight of the balance of the layer. The liquid waste of the upper layer can represent a rough and unstable system, containing both direct and lipophilic emulsions and having a tendency for phase separation. Since the organic-rich layer can still be susceptible to phase separation, it can be removed and admixed with one or more surface active agents to provide a stable, continuous phase. This layer can be processed through the PET apparatus and then stored for future use as potential fuel, or burned, directly at an incinerator. This layer can also be processed with additional fuel and burned according to other embodiments of this invention. The bottom layer which is not as rich with organic matter as the top layer can include as much as 50 wt. % organic matter as compared with the weight of the bottom layer. The bottom layer can be introduced, in measured amounts, and dispersed in the upper layer. In this embodiment, the upper layer can form a continuous phase and the bottom layer can form the discrete phase. In addition, the bottom layer can be treated according to the aforementioned embodiments of the invention by, for example, combustion after the layer is emulsified with a fuel/surfactant mixture. In one such embodiment, a bottom layer containing approximately 50 wt. % of organic matter can be introduced in measured amounts into liquid fuel such as heavy oil, emulsified according to the so-called PET principles as disclosed hereinabove, and transformed into a homogeneous composition of a finely dispersed lipophilic emulsion. The composition may then be burned in heat generating equipment. Alternatively, the bottom layer can be introduced to a mixture of fuel and surfactant, emulsified and the incinerated or stored for future consumption.

It is noted that since the bottom layer can include heavy metals and other similar compounds, it may be beneficial to subject the bottom layer to separation treatment in order to remove and recycle the heavy metal. Alternatively, the sludge can be subjected to various mechanical and chemical filtration step(s) to remove certain physical and/or chemical impurities.

In one embodiment, the instant invention is capable of producing combustible, stable and highly-dispersed emulsions of water, organic matter and oil in amounts up to 100 tons of fuel per day. Thus, the present invention furthers energy cost savings and eliminates the need for waste storage facilities existing in ports and other industrial waste storage.

Examples of savings that can be obtained according to the embodiments of the invention are as follows. One ton heavy oil treated with 1 wt. % or less stabilizer can be combined with one ton of petrochemical waste containing 30 wt. % organic and 70 wt. % water. The mixture can then be subject to nano-emulsification to produce approximately two tons of nano-emulsified fuel. To generate adequate heat for evaporation of 700 kg of water, combustion of approximately 100 kg of oil waste is required. This can result in approximately 200 kg of useful fuel. Hence, 1,000+200 kg=1,200 Kg of useful fuel can be made available. The final result can yield 20% of additional fuel produced plus elimination of existing oil waste (including cost saving realized on storage, transportation and environmental waste management). In addition, since the new fuel contains an appreciable amount of water, the combustion products are environmentally safe and sound. The existing operations show the following: removal of oil-contaminated water, considerable lowering of the flame height, decrease of slag formation in the throughput section of the boiler, decrease of the coefficient of excess air, decrease in the temperature of the outlet gases, lowering of the CO content up to 45% of its initial value, lowering of NOₓ content by approximately 20%, an approximate decrease of 2.7 kg of fuel consumption for production of 1 Kcal.

The embodiments of the invention are further illustrated through the following non-limiting and exemplary embodiments:

### EXAMPLE 1

Sludge and slurry, including waste sludge formed during transit, can be obtained from ships and barges. Typically, the waste includes approximately 30% organic material with an approximate heat capacity of 10,200 Kcal/kg. In accordance with the described method, emulsions based on heavy oil residual No. 6 (Mazut M100™) can be prepared having the approximate heat capacity of 10,000 cal/kg. The water content in the final emulsion can be maintained at 10 wt. %. Using a dosimeter pump, the sludge water can be introduced into the heavy oil in a ratio of 1 to 6 and a temperature of approximately 60° C. to form a rough emulsion. The rough emulsion can then be processed by a disc-shaped pulsating apparatus. The disperser, operating on the principle pulse energy transformation (PET) as discussed above, can produce a fine dispersion of water and undesirable paraffinic compounds in heavy oil to produce a substantially emulsified fuel having nano-dispersion characteristics. The emulsified fuel can then be burned in a heat generating installation such as a steam boiler. According to a comparative experiment, a 2% boiler energy increase can be obtained by using an emulsion containing 10% water versus a water-less emulsion. The increase in efficiency of 1 kg of sludge according to an embodiment of the invention can be summarized in the following manner. First, a 2% efficiency increase of the boiler translates to approximately 1200 Kcal/kg. Second, the added heat capacity of the sludge water (with 92% boiler efficiency) results in approximately 2,815.2 Kcal/kg. Thus, the total energy effect in the disposal of one kg of sludge waters is thus 3,015.2 kcal/kg.

### EXAMPLE 2

The sludge described in Example 1 containing 30% of organic matter with heat capacity of 10,200 Kcal/Kg and representing an unstable system with the tendency to separate into layers can be subjected to storage in a separating tank. After settlement, the upper layer containing 3% water can be removed. Approximately 1% of a surface active agent can be added to the upper layer. Next, heavy oil or sludge can be added until the water content in the system reaches 50% and forms a rough emulsion. The rough emulsion can be processed by a pulsating apparatus as discussed above until a finely-dispersed and stable emulsion is formed. The emulsion can then be burned in appropriate heat generating equipment.

In Example 2 the surface layer of fluid waste can consist of liquid fuel and can be further enriched by organic matter which can act as additional fuel. Using this technology can considerably decrease the energy demands and cost of the purification equipment since the preparation of the emulsified fuel can be as much as sixty percent of the total amount of the heavy oil used. Moreover, such treatments can substantially reduce the amount of organic content thereby ensuring that the organic contaminants do not exceed 30 g/m³ when the remainder of the liquid waste enters the biological purification.

The energy related effects accompanying the destruction of one kg of sludge can be summarized as follows. The heat capacity of the emulsified fuel of Example 2 is approximately 10,200×50%=5,100 Kcal/Kg. Energy is required for evaporating water for heating steam to a temperature where gases emit from the boiler (approximately 180° C.). We use GH₂O to represent the heat used per one kg of emulsion fuel and Q to represent the weight of water (initially 0.5 kg.) Heat content of water at the initial temperature 20° C. is approximately 20 Kcal/Kg and heat content of superheated steam at 170 C. is 677.9 Kcal/Kg.

Thus GH₂O=0.5 kg (677.9-20) Kcal/Kg=329.95

The thermal effect, assuming a boiler efficiency of 92% is:

(5,100−328.95)×0.92=4,389.4 Kcal/Kg

Considering that in one kg of sludge approximately 60% can generate energy and the remainder typically does not contribute to the thermal effect or the biological purification:

4,389.4×0.6=2,693.6 Kcal/Kg

Thus, comparing the first and the second examples it is evident that in Example 1 the specific thermal effect is higher. This can be explained by the fact that in Example 1 sludge was mixed with the heavy oil in the ratio 1 to 6 corresponding to about 10% water in the emulsion. With such values, the amount of water is sufficient to provide an improvement in the spraying of the heavy oil. That is, the mixing of sludge with heavy oil in the relatively small amounts leads to the improvement in the combustion of the entire mass of the emulsion fuel.

The inventors' experiments show that when heavy oil without water is mixed with water to form a finely dispersed emulsion, the optimal water content will occur within the range of 8 to 12% where the lower value is characteristics for low viscosity heavy oil and higher values for highly viscous heavy oils. These results, however, are not intended to limit the scope of the invention and it will be readily recognized by an ordinary skill artisan that the water content can be varied to optimize combustion. Additional experiments show that viscosity of heavy oil is lower when emulsified with water.

Thus, using energy considerations, the conditions for the process in the first example can be considered advantageous. Also, in the embodiment of Example 1 surfactant need not be used and a purification process is not needed. Notwithstanding, the process embodied in Example 2 is advantageous in that it does not require a special liquid fuel which can be costly. The embodiments represented herein can be efficient in treating any combination of water-containing organic waste and can be used with a wide range of liquid fuels. The processes embodied in the invention can be adapted to treat 45 tons of water/emulsion fuel per hour.

What is claimed is:

1. A method for treating waste containing organic mater comprising:
adding water to the waste,
preparing a composition comprising at least one surface active agent and fuel,
introducing the organic matter in measured amounts to the fuel to form a final composition,
emulsifying the final composition, and burning the final composition.

2. The method of claim 1, wherein the organic matter is present in an amount of 20-30 wt. %.

3. The method of claim 1, wherein the organic matter is present in an amount of 30-50 wt. %.

4. The method of claim 1, wherein the organic matter is present in an amount of 50-80 wt. %.

5. A system for disposal of sludge containing organic mater and water, the system comprising:
a supply of sludge containing organic matter and water;
a supply of at least one surfactant;
a supply of at least one type of liquid fuel;
a nano-disperser adapted to provide an emulsion containing the sludge, said at least one surfactant and the liquid fuel, the emulsion having a lipophilic continuous phase and having a discrete phase having particles substantially one nano-meter in diameter;
and wherein the total water content of the emulsion is in the range of 5-60 wt. %.

6. The system of claim 5, wherein the total water content of the emulsion is 10-20 wt. %.

7. The system of claim 5, wherein the total water content of the emulsion is 20-30 wt. %.

8. The system of claim 5, wherein the total water content of the emulsion is 30-40 wt. %.

9. A method for treating heavy oil contaminated with water, the method comprising;
providing a combustible heavy oil having substantially not more than 25 wt % water,
subjecting the contaminated heavy oil to a dispersion process to produce an emulsion having a continuous and a discrete phase, the discrete phase having particles with a diameter of substantially one nano-meter.

10. The method of claim 9, wherein the emulsion further includes a surfactant.

11. The method of claim 9, further comprising providing a liquid fuel prior to subjecting the contaminated heavy oil to the dispersion process.

12. The method of claim 9, wherein the heavy oil contains substantially not more than 20 wt. % water.

13. The method of claim 9, wherein the heavy oil contains substantially not more than 10 wt. % water.
